(19) United States
(12) Patent Application Publication
(10) Pub. No.: US 2009/0169943 A1
(43) Pub. Date: Jul. 2, 2009

(54) SOLID ELECTROLYTE MULTILAYER MEMBRANE, METHOD AND APPARATUS OF PRODUCING THE SAME, MEMBRANE ELECTRODE ASSEMBLY, AND FUEL CELL

(75) Inventor: Naoyuki Kawanishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJFILM CORPORATION, Minato-ku, Tokyo (JP)

(21) Appl. No.: 11/994,874

(22) PCT Filed: Jul. 5, 2006
(86) PCT No.: PCT/JP2006/313803

§ 371 Date: Jan. 7, 2008

(30) Foreign Application Priority Data
Jul. 7, 2005 (JP) 2005-198383

(51) Int. Cl. H01M 8/10; B29C 41/28; B28B 5/02

(52) U.S. Cl. 429/30; 264/104; 425/71

(57) ABSTRACT

First, second and third dopes (114, 115 and 116) containing a solid electrolyte are co-cast from a casting die (89) onto a running belt (82). The casting die (89) is provided with a feed block (119). A catalyst that promotes a redox reaction of electrodes in a fuel cell is added to the first dope (114) and the third dope (116). A casting membrane (112) having a three-layer structure is peeled from the belt (82) as a three-layered membrane (62) and sent to a tenter drier (64). In the tenter drier (64), the membrane (62) is dried in a state that both side edges thereof are held by clips, while stretched so as to have a predetermined width. The membrane (62) is then sent to a drying chamber (69) and the drying thereof is proceeded while supported by rollers.

### TECHNICAL FIELD

The present invention relates to a solid electrolyte multilayer membrane, a method and an apparatus of producing the solid electrolyte multilayer membrane, and a membrane electrode assembly and a fuel cell using the solid electrolyte multilayer membrane. The present invention especially relates to a solid electrolyte multilayer membrane having excellent proton conductivity used for a fuel cell, a method and an apparatus of producing the solid electrolyte multilayer membrane, and a membrane electrode assembly and a fuel cell using the solid electrolyte multilayer membrane.

### BACKGROUND ART

A lithium ion battery and a fuel cell that are used as a power source for portable devices have been actively studied in recent years. A solid electrolyte used for the above mentioned battery or cell is also actively studied. The solid electrolyte is, for instance, a lithium ion conducting material or a proton conducting material.

The proton conducting material is generally in the form of a membrane. The solid electrolyte in membrane form, which is used as a solid electrolyte layer of the fuel cell and the like, and its producing method have been proposed. For instance, Japanese Patent Laid-Open Publication No. 9-320617 discloses a method of producing a solid electrolyte membrane by immersing a polyvinylidene fluoride resin in a liquid in which an electrolyte and a plasticizer are mixed. Japanese Patent Laid-Open Publication No. 2001-307752 discloses a method of producing a proton conducting membrane by synthesizing an inorganic compound in a solution containing an aromatic polymer compound with the sulfonic acid group, and removing a solvent therefrom. In this method, oxides of silicon and phosphoric acid derivative are added to the solution in order to improve micropores. Japanese Patent Laid-Open Publication No. 2002-231270 discloses a method of producing an ion-exchange membrane. In this method, metal oxide precursor is added to a solution containing an ion-exchange resin, and a liquid is obtained by applying hydrolysis and polycondensation reaction to the metal oxide precursor. The ion-exchange membrane is obtained by casting the liquid. Japanese Patent Laid-Open Publication No. 2004-079378 discloses a method of producing a proton conducting membrane. In this method, a polymer membrane with a proton conductivity is produced by a solution casting method. The membrane is immersed in an aqueous solution of an organic compound soluble to water and having a boiling point of not less than 100° C., and is allowed to swell to equilibrium. Water is then evaporated by heating. In this way, the proton conducting membrane is produced. Japanese Patent Laid-Open Publication No. 2004-131530 discloses a method of producing a solid electrolyte membrane by dissolving a compound consisting essentially of polybenzimidazole having the anionic groups into an alcohol solvent containing tetraalkylammonium hydroxide and having a boiling point of not less than 90° C.

A melt-extrusion method and the solution casting method are well known methods of forming a membrane from a polymer. According to the melt-extrusion method, the membrane can be formed without using a solvent. However, this method has problems in that the polymer may denature by heating, impurities in the polymer remain in the produced membrane, and the like. On the other hand, the solution casting method has a problem in that its producing apparatuses become large and complicated since the method requires a producing apparatus of a solution, a solvent recovery device and the like. However, this method is advantageous since a heating temperature of the membrane can be relatively low and it is possible to remove the impurities in the polymer while producing the solution. The solution casting method has a further advantage in that the produced membrane has better planarity and smoothness than the membrane produced by the melt-extrusion method.

When the solid electrolyte membrane produced in this way is used for the fuel cell, a catalyst layer is provided on both surfaces of the solid electrolyte membrane in order to promote redox reaction taken place on electrodes of the fuel cell. The catalyst members and the solid electrolyte membrane have been conventionally produced separately and combined later. In addition, the electrodes for the redox reaction are incorporated in the fuel cell. The electrodes are also produced in a separate step and combined with the catalyst members and the solid electrolyte membrane. As a method of combining them, there is a press-bonding method, which is one type of lamination. The solid electrolyte membrane and the catalyst members are relatively expensive, hence continuously producing them carries a risk unless stable producing conditions are established. Accordingly, it cannot be helped to make each member separately and combine them later, even though this method is inefficient.

In view of this, methods for continuously producing a so-called membrane electrode assembly (MEA) having the solid electrolyte, the catalyst layers and the electrodes are proposed. For example, International Publication No. WO99/34466 (corresponding to National Publication of Translated Version No. 2002-500422) discloses a method in which an electrolyte layer and two catalyst layers are co-extruded from a die, and electrodes sheets made from carbon fiber paper are adhered thereto by pressing them between calendar rolls. The above publication also discloses a method which deposits extruded catalyst layers between pre-formed electrolyte sheet and pre-formed electrode sheets. The above publication further discloses a method which deposits extruded solid electrolyte layer between pre-formed electrode sheets and pre-formed two catalyst layers, and adhered together by pressing them between the calendar rolls.

Japanese Patent Laid-Open Publication No. 2004-047489 discloses a method in which electrolyte ink for forming a first layer, catalyst layer ink for forming a second layer and diffusion layer ink for forming a third layer are simultaneously injected to an applying head so as to be discharged in multilayer forms on a surface of a continuously running member. In this way, a MEA is formed.

However, in the above-noted Publication No. 9-320617, the solution casting method is denied, and there remains a problem in that the impurities contained in raw materials remain in the produced membrane. The methods disclosed in the above-noted Publication Nos. 2001-307752, 2002-231270, 2004-079378 and 2004-131530 are on a limited scale and not intended to be applied in mass production. The method disclosed in the above-noted Publication No. 2001-307752 has a problem in that it is difficult to disperse a complex consisted of the polymer and the inorganic compound. The method disclosed in the above-noted Publication No. 2002-231270 has a problem in that its membrane producing step is complicated. The method disclosed in the above-noted Publication No. 2004-079378 has a problem in that the produced membrane is not uniform in planarity and smoothness since it has micropores formed during the immersing in the aqueous solution. Any solution for this problem is not cited in the disclosure. Although it is cited in the disclosure that various solid electrolyte membranes can be produced by the solution casting method, any specific method therefor is not cited. The method disclosed in the above-noted Publication No. 2004-131530 limits raw materials to be used and does not mention the usage of other materials having excellent properties.

In order to produce the fuel cell efficiently, at least the solid electrolyte layer and catalyst layers should be formed at the same time. In addition, the produced fuel cell should have high and uniform quality. According to the methods described in International Publication No. WO99/34466 and Japanese Patent Laid-Open Publication No. 2004-047489, efficiency of producing the fuel cell may be improved at some level since the fuel cell is produced integrally. However, it cannot be said that the methods are capable of continuously producing fuel cells integrally to have uniform quality without loss of the expensive catalyst and solid electrolyte. In addition, both publications do not disclose or suggest improvement of fuel cell properties. The fuel cell properties synergistically elicit respective properties of the solid electrolyte and the catalyst when they are laminated. For example, the solid electrolyte layer is desired to have high selectivity in mass transfer. That is, the solid electrolyte is desired to carry (transmit) only protons, and to block fuels such as hydrogen or methanol. Meanwhile, the catalyst layer is desired to have low resistance to electron transfer, and to carry protons, fuel molecules or oxygen molecules with no selectivity. Thus concrete methods for continuously laminating the layers having opposite properties, and to assure uniform quality of the produced fuel cell should be proposed. Without such methods, it is difficult to realize mass production of the fuel cell having high performance, at low cost.

It is an object of the present invention to provide a solid electrolyte multilayer membrane that has uniform quality and excellent ionic conductivity continuously formed from a solid electrolyte, a method and an apparatus of producing the solid electrolyte multilayer membrane, and a membrane electrode assembly and a fuel cell using the solid electrolyte multilayer membrane.

### DISCLOSURE OF INVENTION

In order to achieve the above and other objects, a method of producing a solid electrolyte multilayer membrane of the present invention includes the step of casting a first dope and a second dope onto a running support so as to form a casting membrane having a first layer of the first dope and a second layer of the second dope. The first dope contains an organic solvent and a solid electrolyte that is to be a solid electrolyte layer of a fuel cell. The second dope contains the solid electrolyte, the organic solvent and a catalyst that promotes a redox reaction of electrodes in the fuel cell. The method further includes the steps of peeling the casting membrane as a wet membrane from the support; performing a first drying of the wet membrane in a state that both side edges thereof are held by holding devices; and performing a second drying of the wet membrane supported by rollers to form the solid electrolyte multilayer membrane. The second drying step is performed after the first drying step.

It is preferable that the first dope is cast from a first casting die and the second dope is cast from a second casting die disposed at a downstream of the first casting die. It is preferable that wet membrane is brought into contact with a compound that is a poor solvent of the solid electrolyte. It is preferable that the catalyst includes at least one of Au, Ir, Pt, Rh, Ru, W, Ta, Nb, Ti Pd, Bi, Ni, Co, Fe and Hf. It is also preferable that the catalyst is an alloy of these metals.

It is preferable that a thickness of a layer formed from the first dope in the solid electrolyte multilayer membrane is 20 μm to 800 μm. This layer is derived from the first layer of the casting film. It is preferable that a thickness of a layer formed from the second dope in the solid electrolyte multilayer membrane is 10 μm to 500 μm. This layer is derived from the second layer of the casting film.

It is preferable that a third dope containing the solid electrolyte, the organic solvent and the catalyst is cast such that the first dope is interposed between the second dope and the third dope. When the first dope and the second dope are cast from the first casting die and second casting die, respectively, the third dope is preferably cast from a third casting die that is deposed at an upstream of the first casting die. It is preferable that the catalyst in the second dope and the catalyst in the third dope are different from each other. The solid electrolyte multilayer membrane of the present invention is produced according to the above-mentioned method.

An apparatus of producing a solid electrolyte multilayer membrane of the present invention includes a casting device, a first drying device and a second drying device. The casting device casts plural dopes from a casting die onto a running support so as to form a layered casting membrane and peels the casting membrane as a layered wet membrane. The plural dopes are a first dope and a second dope. The first dope contains an organic solvent and a solid electrolyte that is to be a solid electrolyte layer of a fuel cell. The second dope contains the solid electrolyte, the organic solvent and a catalyst that promotes a redox reaction of electrodes in the fuel cell. The first drying device dries the wet membrane in a state that both side edges thereof are held by holding devices. The second drying device dries the wet membrane supported by rollers to form the solid electrolyte multilayer membrane. The second drying device is disposed at a downstream of the first drying device.

A membrane electrode assembly of the present invention includes the above-mentioned solid electrolyte multilayer membrane, an anode and a cathode. The anode is adhered to one surface of the solid electrolyte multilayer membrane, and generates protons from a hydrogen-containing material supplied from outside. The cathode is adhered to the other surface of the solid electrolyte multilayer membrane, and synthesizes water from the protons permeated through the solid electrolyte multilayer membrane and gas supplied from outside.

A fuel cell of the present invention includes the above-mentioned membrane electrode assembly and current collectors. One of the current collectors is provided in contact with the anode, and the other current collector is provided in contact with the cathode. The current collector on the anode side receives and passes electrons between the anode and outside, whereas the current collector on the cathode side receives and passes the electrons between the cathode and outside.

According to the present invention, it is possible to continuously produce the solid electrolyte multilayer membrane provided with the catalyst layers that promote the redox reaction at a low cost. The produced solid electrolyte multilayer membrane has uniform quality and excellent ionic conductivity. When the membrane electrode assembly using this solid electrolyte multilayer membrane is used for the fuel cell, the fuel cell realizes an excellent electromotive force.

### BRIEF DESCRIPTION OF DRAWINGS

FIG. 1 is a schematic diagram illustrating a dope producing apparatus;

FIG. 2 is a schematic diagram illustrating a membrane producing apparatus;

FIG. 3 is a sectional view illustrating a simultaneous co-casting device;

FIG. 4 is a schematic diagram illustrating a sequential co-casting device;

FIG. 5 is a sectional view illustrating a structure of a membrane electrode assembly that uses a solid electrolyte membrane of the present invention; and

FIG. 6 is an exploded sectional view illustrating a structure of a fuel cell that uses the membrane electrode assembly of the present invention.

### BEST MODE FOR CARRYING OUT THE INVENTION

Embodiments of the present invention are described below in detail. The present invention, however, is not limited to the following embodiments. A solid electrolyte multilayer membrane of the present invention is first explained and followed by a producing method thereof.

[Material]

In the present invention, a polymer having a proton donating-group is used as a solid electrolyte, which is formed into a membrane by a producing method described later. The polymer having the proton donating-group is not particularly limited, but may be well-known proton conducting materials having an acid residue. For example, polymer compounds formed by addition polymerization having a sulfonic acid group in side chains, poly(meth)acrylate having a phosphoric acid group in side chains, sulfonated polyether etherketon, sulfonated polybenzimidazole, sulfonated polysulfone, sulfonated heat-resistant aromatic polymer compounds and the like are preferably used. As the polymer formed by addition polymerization having a sulfonic acid group in side chains, there are perfluorosulfonic acid, as typified by Nafion (registered trademark), sulfonated polystyrene, sulfonated polyacrylonitrile styrene, sulfonated polyacrylonitrile butadiene-styrene and the like. As the sulfonated heat-resistant aromatic polymer compounds, there are sulfonated polyimide and the like.

Substances described in, for example, Japanese Patent Laid-Open Publication Nos. 4-366137, 6-231779 and 6-342665 are the preferable examples of the perfluorosulfonic acid, and the substance represented by the following chemical formula 1 is especially preferable above all. However, in the chemical formula 1, m is in the range of 100 to 10000, preferably in the range of 200 to 5000 and more preferably in the range of 500 to 2000. In addition, n is in the range of 0.5 to 100, and especially preferably in the range of 5 to 13.5. Moreover, x is nearly equal to m, and y is nearly equal to n.

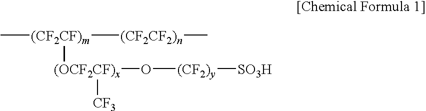

Compounds described in, for example, Japanese Patent Laid-Open Publication Nos. 5-174856 and 6-111834, or the substance represented by the following chemical formula 2 are the preferable examples of the sulfonated polystyrene, the sulfonated polyacrylonitrile styrene and the sulfonated polyacrylonitrile butadiene-styrene.

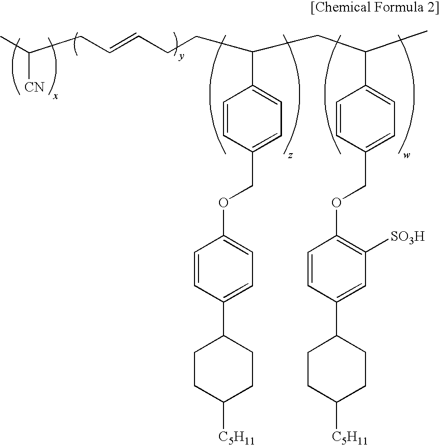

Substances described in, for example, Japanese Patent Laid-Open Publication Nos. 6-49302, 2004-10677, 2004-345997, 2005-15541, 2002-110174, 2003-100317, 2003-55457, 9-245818, 2003-257451 and 2002-105200, and International Publication No. WO97/42253 (corresponding to National Publication of Translated Version No. 2000-510511) are the examples of the sulfonated heat-resistant aromatic polymer compounds, and the substances represented by the following chemical formulae 3 and 4 are especially preferable above all.

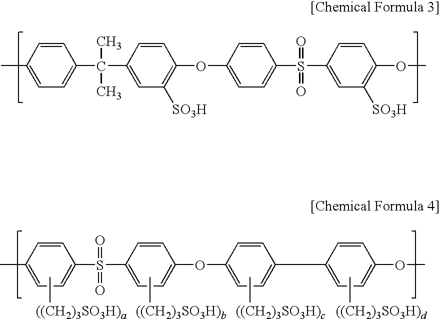

Sulfonation reaction on the process of obtaining the above-mentioned compounds can be performed in accordance with various synthetic methods described in the disclosed publications. Sulfuric acid (concentrated sulfuric acid), fuming sulfuric acid, gaseous or liquid sulfur trioxide, sulfur trioxide complex, amidosulfuric acid, chlorosulfonic acid and the like are used as sulfonating agents. Hydrocarbon (benzene, toluene, nitrobenzene, chlorobenzene, dioxetane and the like), alkyl halide (dichloromethane, chloroform, dichloroethane, tetrachloromethane and the like) and the like are used as a solvent. Reaction temperature in the sulfonation reaction is determined within the range of −20° C. to 200° C. in accordance with the sulfonating agent activity. It is also possible to previously introduce a mercapto group, a disulfide group or a sulfinic acid group in a monomer, and synthesize the sulfonated compound by the oxidation reaction with an oxidant. In this case, hydrogen peroxide, nitric acid, bromine water, hypochlorite, hypobromite, potassium permanganate, chromic acid and the like are used as the oxidant. Water, acetic acid, propionic acid and the like are used as the solvent. The reaction temperature according to this method is determined within the range of a room temperature (for example, 25° C.) to 200° C. in accordance with the oxidant activity. It is also possible to previously introduce a halogeno-alkyl group in the monomer, and synthesize the sulfonated compound by the substitution reaction of a sulfite, hydrogen sulfite and the like. In this case, water, alcohol, amide, sulfoxide, sulfone and the like are used as the solvent. The reaction temperature according to this method is determined within the range of the room temperature (for example, 25° C.) to 200° C. The solvent used for the above-mentioned sulfonation reactions can be a mixture of two or more substances.

In the reaction process to synthesize the sulfonated compound, an alkyl sulfonating agent can be used, and Friedel-Crafts reaction (Journal of Applied Polymer Science, Vol. 36, 1753-1767, 1988) using a sulfone and AlCl₃ is a common method. When using the alkyl sulfonating agent for the Friedel-Crafts reaction, hydrocarbon (benzene, toluene, nitrobenzene, acetophenon, chlorobenzene, trichlorobenzene and the like), alkyl halide (dichloromethane, chloroform, dichloroethane, tetrachloromethane, trichloroethane, tetrachloroethane and the like) and the like are used as the solvent. The reaction temperature is determined in the range of the room temperature to 200° C. The solvent used for the above-mentioned Friedel-Crafts reaction can be a mixture of two or more substances.

The solid electrolyte preferably has the following properties. An ionic conductivity is preferably not less than 0.005 S/cm, and more preferably not less than 0.01 S/cm at a temperature of 25° C. and at a relative humidity of 70%, for example. Moreover, after the solid electrolyte membrane has been soaked in a 50% methanol aqueous solution for a day at the temperature of 18° C., the ionic conductivity is not less than 0.003 S/cm, and more preferably not less than 0.008 S/cm. At this time, it is particularly preferable that a percentage of reduction in the ionic conductivity of the solid electrolyte as compared to that before the soaking is not more than 20%. Furthermore, a methanol diffusion coefficient is preferably not more than 4×10⁻⁷ cm²/sec, and especially preferably not more than 2×10⁻⁷ cm²/sec.

As to strength, the solid electrolyte membrane preferably has elastic modulus of not less than 10 MPa, and especially preferably of not less than 20 MPa. Note that the measuring method of the elastic modulus is described in detail in paragraph [0138] in Japanese Patent Laid-Open Publication No. 2005-104148. The above-noted values of the elastic modulus are obtained by a tensile tester (manufactured by Toyo Baldwin Co., Ltd.). In order to obtain the elastic modulus of the solid electrolyte by other testing methods or testers, it is preferable to previously correlate the value thereof with that of the above-noted testing method and the tester.

As to durability, after a test with time in which the solid electrolyte membrane has been soaked into the 50% methanol aqueous solution at a constant temperature, a percentage of change in each of weight, ion exchange capacity, and the methanol diffusion coefficient as compared to that before the soaking is preferably not more than 20%, and especially preferably not more than 15%. Moreover, in a test with time in hydrogen peroxide, the percentage of change in each of the weight, the ion exchange capacity and the methanol diffusion coefficient as compared to that before the soaking is preferably not more than 20%, and especially preferably not more than 10%. Furthermore, coefficient of volume expansion of the solid electrolyte membrane in the 50% methanol aqueous solution at a constant temperature is preferably not more than 10%, and especially preferably not more than 5%.

In addition, it is preferable that the solid electrolyte has stable ratios of water absorption and water content. It is also preferable that the solid electrolyte has extremely low solubility in alcohol, water, or a mixture of alcohol and water to the extent that it is practically negligible. It is also preferable that weight reduction and shape change of the solid electrolyte membrane after it has been soaked in the above-mentioned liquid are also small enough to be practically negligible.

When the solid electrolyte is formed into a membrane, an ion-conducting direction is preferably higher in a thickness direction of the membrane as compared to other directions thereof. The ionic conductivity basically depends on a ratio of the ionic conductivity to methanol transmission coefficient. Therefore, the ion-conducting direction may be random. A ratio of the ionic conductivity to methanol diffusion coefficient is represented as performance index. The higher the index is, the higher the ionic conductivity of the solid electrolyte is. As long as the solid electrolyte has uniform performance index, ionic resistance and the methanol transmission of the solid electrolyte membranes can be uniform by adjusting the membrane thickness. The thickness of the membrane is preferably in the range of 10 μm to 300 μm. The ionic resistance is proportional to the thickness, while the methanol transmission amount is inversely proportional to the thickness. Therefore, when the ionic conductivity and the methanol diffusion coefficient are both high in the solid electrolyte, it is especially preferable to produce the membrane with a thickness of 50 μm to 200 μm. When the ionic conductivity and the methanol diffusion coefficient are both low in the solid electrolyte, it is especially preferable to produce the membrane with the thickness of 20 μm to 100 μm.

Allowable temperature limit is preferably not less than 200° C., more preferably not less than 250° C., and especially preferably not less than 300° C. The allowable temperature limit here means the temperature at which reduction in weight of the solid electrolyte membrane reaches 5% as it is heated at a rate of 1° C./min. Note that the weight reduction is calculated with the exception of evaporated contents of water and the like.

When the solid electrolyte is formed in the membrane form and used for the fuel cell, the maximum power (output) density thereof is preferably not less than 10 mW/cm².

By use of the above-described solid electrolyte, it is possible to produce a solution dope preferable for the membrane production, and at the same time, it is possible to produce the solid electrolyte membrane preferable for the fuel cell. The solution preferable for the membrane production is, for example, a solution whose viscosity is relatively low, and from which foreign matters are easily removed through filtration. Note that the obtained solution is hereinafter referred to as the dope.

Any organic compound capable of dissolving the polymer as the solid electrolyte can be the solvent of the dope. For example, there are aromatic hydrocarbon (for example, benzene, toluene and the like), halogenated hydrocarbon (for example, dichloromethane, chlorobenzene and the like), alcohol (for example, methanol, ethanol, n-propanol, n-butanol, diethylene glycol and the like), ketone (for example, acetone, methylethyl ketone and the like), ester (for example, methylacetate, ethylacetate, propylacetate and the like), ether (for example, tetrahydrofuran, methyl cellosolve and the like), nitrogen compound (N-methylpyrrolidone (NMP), N,N-dimethylformamide (DMF), N,N′-dimethylacetamide (DMAc) and the like) and so forth. Note that the solvent may be a mixture of a plurality of the substances.

In order to improve the various properties of the solid electrolyte membrane, it is possible to add additives to the dope. As the additives, there are antioxidants, fibers, fine particles, water absorbing agents, plasticizers and compatibilizing agents and the like. It is preferable that a concentration of these additives is in the range of not less than 1 wt. % and 30 wt. % or less when the entire solid contents of the dope is 100 wt. %. Note, however, that the concentration and the sorts of the additives have to be determined not to adversely affect on the ionic conductivity. Hereinafter, the additives are explained in detail.

As the antioxidants, (hindered) phenol-type compounds, monovalent or divalent sulfur-type compounds, trivalent phosphorus-type compounds, benzophenone-type compounds, benzotriazole-type compounds, hindered amine-type compounds, cyanoacrylate-type compounds, salicylate-type compounds, oxalic acid anilide-type compounds are the preferable examples. The compounds described in Japanese Patent Laid-Open Publication Nos. 8-053614, 10-101873, 11-114430 and 2003-151346 are the specific examples thereof.

As the fibers, perfluorocarbon fibers, cellulose fibers, glass fibers, polyethylene fibers and the like are the preferable examples. The fibers described in Japanese Patent Laid-Open Publication Nos. 10-312815, 2000-231938, 2001-307545, 2003-317748, 2004-063430 and 2004-107461 are the specific examples thereof.

As the fine particles, titanium oxide, zirconium oxide and the like are the preferable examples. The fine particles described in Japanese Patent Laid-Open Publication Nos. 2003-178777 and 2004-217931 are the specific examples thereof.

As the water absorbing agents, that is, the hydrophilic materials, cross-linked polyacrylate salt, starch-acrylate salt, poval (polyvinyl alcohol), polyacrylonitrile, carboxymethyl cellulose, polyvinyl pyrrolidone, polyglycol dialkyl ether, polyglycol dialkyl ester, synthetic zeolite, titania gel, zirconia gel and yttria gel are the preferable examples. The water absorbing agents described in Japanese Patent Laid-Open Publication Nos. 7-135003, 8-020716 and 9-251857 are the specific examples thereof.

As the plasticizers, phosphoric acid ester-type compound, chlorinated paraffin, alkyl naphthalene-type compound, sulfone alkylamide-type compound, oligoether group, aromatic nitrile group are the preferable examples. The plasticizers described in Japanese Patent Laid-Open Publication Nos. 2003-288916 and 2003-317539 are the specific examples thereof.

As the compatibilizing agents, those having a boiling point or a sublimation point of not less than 250° C. are preferable, and those having the same of not less than 300° C. are more preferable.

The dope may contain various kinds of polymer compounds for the purpose of (1) enhancing the mechanical strength of the membrane, and (2) improving the acid concentration in the membrane.

For the purpose of (1), a polymer having a molecular weight in the range of 10000 to 1000000 or so and well compatible with (soluble to) the solid electrolyte is preferably used. For example, the polymer such as perfluorinated polymer, polystyrene, polyethylene glycol, polyoxetane, polyether ketone, polyether sulfone, and the polymer compound having the repeating unit of at least two of these polymers are preferable. Preferably, the polymer content of the membrane is in the range of 1 wt. % to 30 wt. % of the total weight. It is also possible to use the compatibilizing agent in order to enhance the compatibility of the polymer with the solid electrolyte. As the compatibilizing agent, those having the boiling point or the sublimation point of not less than 250° C. are preferable, and those having the same of not less than 300° C. are more preferable.

For the purpose of (2), proton acid segment-having polymer, and the like are preferably used. Perfluorosulfonic acid polymers such as Nafion (registered trademark), sulfonated polyether etherketon having a phosphoric acid group in side chains, and the sulfonated heat-resistant aromatic polymers such as sulfonated polyether sulfone, sulfonated polysulfone, sulfonated polybenzimidazole and the like are the preferable examples thereof. Preferably, the polymer content of the membrane is in the range of 1 wt. % to 30 wt. % of the total weight.

When the obtained solid electrolyte membrane is used for the fuel cell, an active metal catalyst that promotes the redox reaction of anode fuel and cathode fuel may be added to the dope. By adding the active metal catalyst, the fuel having penetrated into the solid electrolyte from one electrode is well consumed inside the solid electrolyte and does not reach the other electrode, and therefore this is effective for preventing a crossover phenomenon. The active metal catalyst is not particularly limited as long as it functions as an electrode catalyst, but platinum or platinum-based alloy is especially preferable.

[Dope Production]

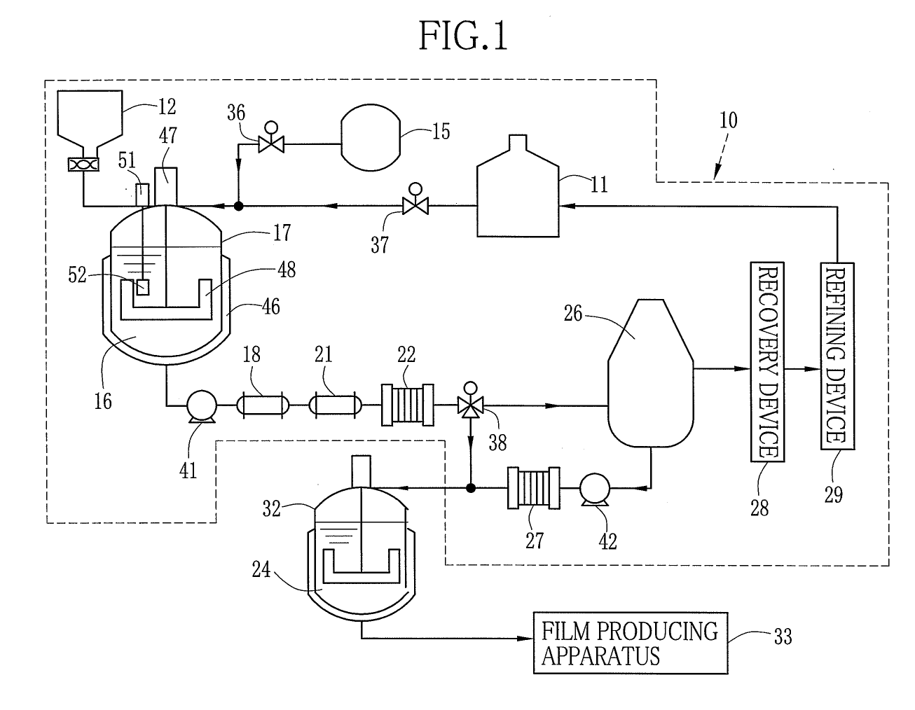

In FIG. 1, a dope producing apparatus is shown. Note, however, that the present invention is not limited to the dope producing apparatus shown in FIG. 1. A dope producing apparatus 10 is provided with a solvent tank 11 for storing the solvent, a hopper 12 for supplying the solid electrolyte, an additive tank 15 for storing the additive, a mixing tank 17 for mixing the solvent, the solid electrolyte and the additive so as to make a mixture 16, a heater 18 for heating the mixture 16, a temperature controller 21 for controlling a temperature of the heated mixture 16, a filtration device 22 for filtering the mixture 16 fed out of the temperature controller 21, a flash device 26 for controlling a concentration of a dope 24 from the filtration device 22, and a filtration device 27 for filtering the concentration-controlled dope 24. The dope producing apparatus 10 is further provided with a recovery device 28 for recovering the solvent, and a refining device 29 for refining the recovered solvent. The dope producing apparatus 10 is connected to a membrane producing apparatus 33 through a stock tank 32. Note that the dope producing apparatus is also provided with valves 36, 37 and 38 for controlling amount of feeding, and feeding pumps 41 and 42. The number and the position of the valves and feeding pumps are changed as appropriate.

First of all, the valve 37 is opened to feed the solvent from the solvent tank 11 to the mixing tank 17. Successively, the solid electrolyte stored in the hopper 12 is sent to the mixing tank 17. At this time, the solid electrolyte may be continuously sent by a feeding device that performs measuring and sending continuously, or may be intermittently sent by a feeding device that measures a predetermined amount of the solid electrolyte first and sends the solid electrolyte of that amount. In addition, an additive solution is sent by a necessary amount from the additive tank 15 to the mixing tank 17 by adjusting the degree of opening of the valve 36.

In the case where the additive is liquid at room temperature, it is possible to send the additive in a liquid state to the mixing tank 17 instead of sending it as solution. Meanwhile, in the case where the additive is solid, it is possible to send the additive to the mixing tank 17 by using the hopper and so forth. When plural kinds of additives are added, the additive tank 15 may contain a solution in which the plural kinds of the additives are dissolved. Alternatively, many additive tanks may be used for respectively containing a solution in which one kind of the additive is dissolved. In this case, the additive solutions are respectively sent to the mixing tank 17 through an independent pipe.

In the above description, the solvent, the solid electrolyte and the additive are sent to the mixing tank 17 in this order. However, this order is not exclusive. For example, the solvent of an appropriate amount may be sent after the solid electrolyte has been sent to the mixing tank 17. By the way, the additive is not necessarily contained in the mixing tank 17 beforehand. The additive may be mixed in a mixture of the solid electrolyte and the solvent during a succeeding process by an in-line mixing method and so forth. To mix a predetermined catalyst into the dope 24, the catalyst may be mixed into the solid electrolyte and the solvent instead of or in addition to the above additives. It is also possible to send the catalyst from the hopper 12 along with the solid electrolyte to make the mixture 16.

It is preferable that the mixing tank 17 is provided with a jacket for covering an outer surface thereof, a first stirrer 48 rotated by a motor 47, and a second stirrer 52 rotated by a motor 51. A temperature of the mixing tank 17 is regulated by heat transfer medium flowing inside the jacket. A preferable temperature range of the mixing tank 17 is −10° C. to 55° C. The first stirrer 48 and the second stirrer 52 are properly selected and used to swell the solid electrolyte in the solvent so that the mixture 16 is obtained. Preferably, the first stirrer 48 has an anchor blade and the second stirrer 52 is a decentering stirrer of dissolver type.

Next, the mixture 16 is sent to the heater 18 by the pump 41. It is preferable that the heater 18 is piping with a jacket (not shown) for letting a heat transfer medium flow between the piping and the jacket. It is further preferable that the heater 18 has a pressure portion (not shown) for pressurizing the mixture 16. By using this kind of the heater 18, solid contents of the mixture 16 are effectively and efficiently dissolved into the solvent under a heating condition or a pressurizing/heating-condition. Hereinafter, the method of dissolving the solid contents into the solvent by heating is referred to as a heat-dissolving method. In this case, it is preferable that the mixture 16 is heated to have the temperature of 60° C. to 250° C.

In stead of the heat-dissolving method, it is possible to perform a cool-dissolving method in order to dissolve the solid contents into the solvent. The cool-dissolving method is a method to promote the dissolution while maintaining the temperature of the mixture 16 or cooling the mixture 16 to have lower temperatures. In the cool-dissolving method, it is preferable that the mixture 16 is cooled to −100° C. to −10° C. The above-mentioned heat-dissolving method and the cool-dissolving method make it possible to sufficiently dissolve the solid electrolyte in the solvent.

After the mixture 16 has reached about a room temperature by means of the temperature controller 21, the mixture 16 is filtered by the filtration device 22 to remove foreign matter like impurities or aggregations contained therein. The filtered mixture 16 is the dope 24. It is preferable that a filter used for the filtration device 22 has an average pore diameter of 50 μm or less.

The dope 24 after the filtration is sent to and pooled in the stock tank 32, and used for producing the membrane.

By the way, the method of swelling the solid contents once and dissolving it to produce the solution as described above takes a longer time as a concentration of the solid electrolyte in the solution increases, and it causes a problem concerning production efficiency. In view of this, it is preferable that the dope is prepared to have a lower concentration relative to an intended concentration, and a concentration process is performed to obtain the intended concentration after preparing the dope. For example, the dope 24 filtered by the filtration device 22 is sent to the flash device 26 by the valve 38, and the solvent of the dope 24 is partially evaporated in the flash device 26 to be concentrated. The concentrated dope 24 is extracted from the flash device 26 by the pump 42 and sent to the filtration device 27. At the time of filtration by the filtration device 27, it is preferable that a temperature of the dope 24 is 0° C. to 200° C. After removing foreign matter by the filtration device 27, the dope 24 is sent to and pooled in the stock tank 32, and used for producing the membrane. Note that the concentrated dope 24 may contain bubbles. It is therefore preferable that a defoaming process is performed before sending the dope 24 to the filtration device 27. As the method for removing the bubbles, various well-known methods are applicable. For example, there is an ultrasonic irradiation method in which the dope 24 is irradiated with an ultrasonic.

Solvent vapor generated due to the evaporation in the flash device 26 is condensed by the recovery device 28 having a condenser (not shown) and becomes a liquid to be recovered. The recovered solvent is refined by the refining device 29 as the solvent to be reused for preparing the dope. Such recovering and reusing are advantageous in terms of production cost, and also prevent adverse effects on human bodies and the environment in a closed system.

By the above method, the dope 24 having the solid electrolyte concentration of 2 wt. % or more and 50 wt. % or less is produced. It is more preferable that the solid electrolyte concentration is 15 wt. % or more and 30 wt. % or less. Meanwhile, as to a concentration of the additive, it is preferable that a range thereof is 1 wt. % or more and is 30 wt. % or less when the entire solid contents of the dope is defined as 100 wt. %.

[Membrane Production]

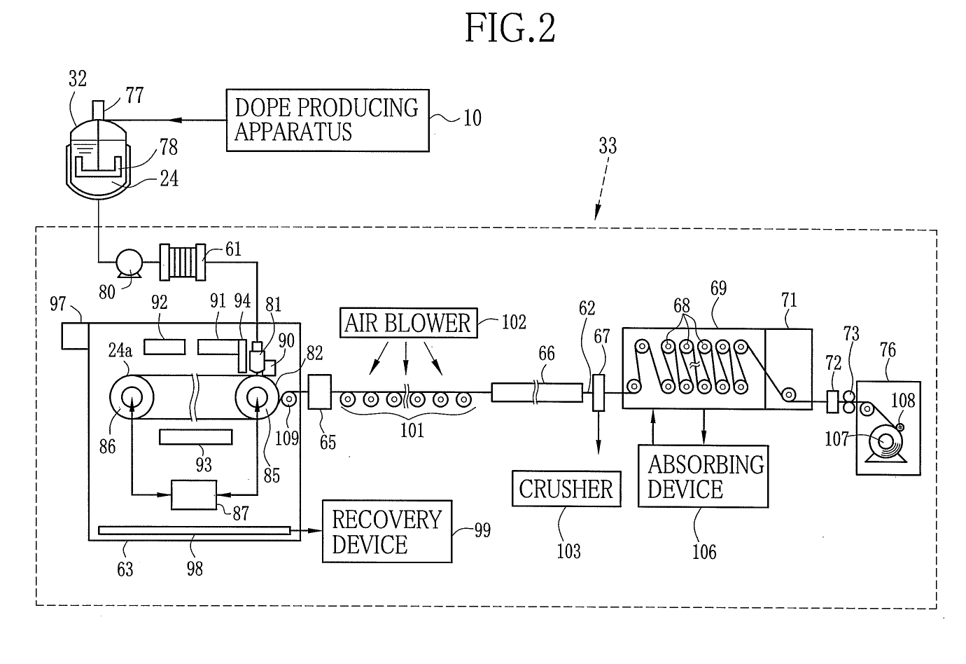

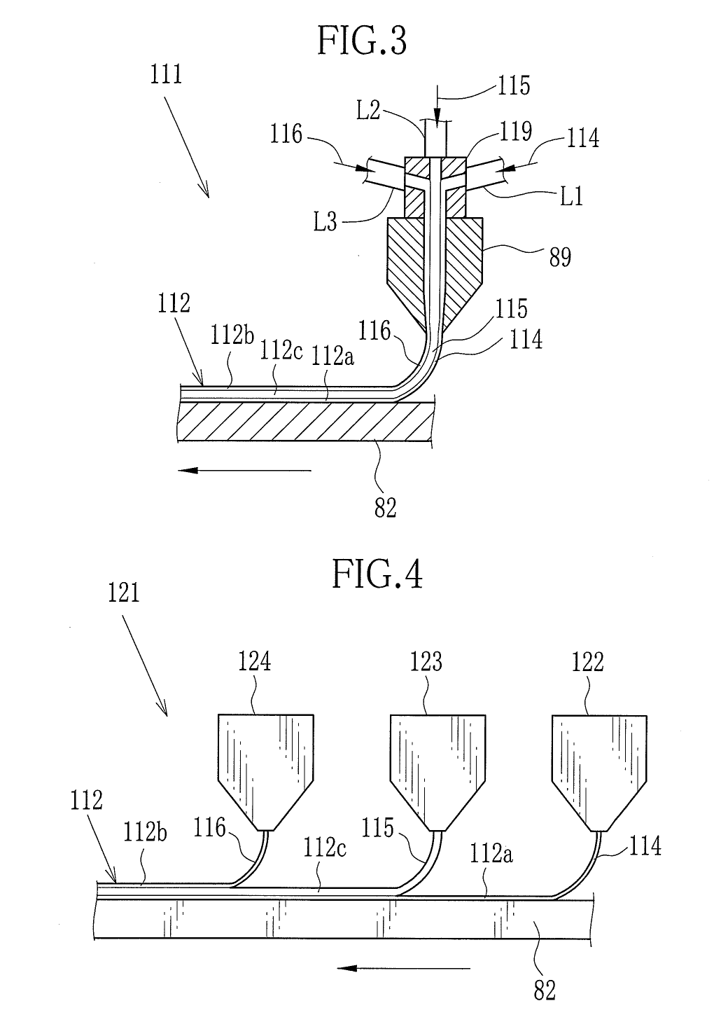

Hereinafter, a method of producing the solid electrolyte multilayer membrane is explained. In FIG. 2, the membrane producing apparatus 33 is shown. Note, however, that the present invention is not limited to the membrane producing apparatus shown in FIG. 2. In the present invention, a plurality of dopes having different compositions from one another is co-casted. Note that FIG. 2 shows only one dope sent from the dope producing apparatus 10 in order to simplify the drawing. The method of co-casting will be explained later in detail with referring to FIGS. 3 and 4.

The membrane producing apparatus 33 is provided with a filtration device 61 for removing foreign matter contained in the dope 24 sent from the stock tank 32; a casting chamber 63 for casting the dope 24 filtered by the filtration device 61 to form a solid electrolyte multilayer membrane (hereinafter, merely referred to as the membrane) 62; a tenter drier 64 for drying the membrane 62 while transporting it in a state that both side edges thereof are held by clips; a poor solvent contact device 65 for bringing a compound, which is a poor solvent of the solid electrolyte, into contact with the membrane 62 containing the solvent, for example, before feeding the membrane 62 into the tenter drier 64; an edge slitting device 67 for cutting off both side edges of the membrane 62; a drying chamber 69 for drying the membrane 62 while transporting it in a state that the membrane 62 is supported by rollers 68; a cooling chamber 71 for cooling the membrane 62; a neutralization device 72 for reducing a charged voltage of the membrane 62; a knurling roller pair 73 for performing emboss processing on both side edges of the membrane 62; and a winding chamber 76 for winding up the membrane 62.

The stock tank 32 is provided with a stirrer 78 rotated by a motor 77. By the rotation of the stirrer 78, deposition or aggregation of the solid contents in the dope 24 is inhibited. The stock tank 32 is connected to the filtration device 61 through a pump 80.

A casting die 81 for casting the dope 24, and a belt 82 as a running support are provided in the casting chamber 63. As a material of the casting die 81, precipitation hardened stainless steel is preferable and it is preferable that a coefficient of thermal expansion thereof is 2×10⁻⁵ (° C.⁻¹) or less. It is preferable that the material has anti-corrosion properties, which is substantially equivalent with SUS316 on a compulsory corrosion examination performed in an electrolyte aqueous solution. Further, it is preferable that the material has anti-corrosion properties in which pitting is not caused at a gas-liquid interface after soaked in a mixed liquid of dichloromethane, methanol and water for three months. Moreover, it is preferable to make the casting die 81 by grinding a material after at least one month has passed from foundry. In virtue of this, the dope 24 uniformly flows inside the casting die 81 and it is prevented that streaks are caused on a casting membrane 24a described later. As to finishing accuracy of a dope contact surface of the casting die 81, it is preferable that surface roughness is 1 μm or less and straightness is 1 μm/m or less in any direction. Slit clearance of the casting die 81 is adapted to be automatically adjusted within the range of 0.5 mm to 3.5 mm. With respect to a corner portion of a lip edge of the casting die 81, a chamfered radius R thereof is adapted to be 50 μm or less in the entire width. Furthermore, it is preferable that the casting die 81 is a coat-hanger type die.

A width of the casting die 81 is not especially limited. However, it is preferable that the width thereof is 1.1 to 2.0 times a width of a membrane as a final product. Moreover, it is preferable that a temperature controller is attached to the casting die 81 to maintain a predetermined temperature of the dope 24 during membrane formation. Furthermore, it is preferable that heat bolts for adjusting a thickness are disposed in a width direction of the casting die 81 at predetermined intervals and the casting die 81 is provided with an automatic thickness adjusting mechanism utilizing the heat bolts. In this case, the heat bolt sets a profile and forms a membrane along a preset program in accordance with a liquid amount sent by the pump 80. In order to precisely control the sending amount of the dope 24, the pump 80 is preferably a high-accuracy gear pump. Furthermore, feedback control may be performed over the automatic thickness adjusting mechanism. In this case, a thickness gauge such as an infrared thickness gauge is disposed at the membrane producing apparatus 33, and the feedback control is performed along an adjustment program on the basis of a profile of the thickness gauge and a detecting result from the thickness gauge. It is preferable that the casting die 81 is capable of adjusting the slit clearance of the lip edge to be ±50 μm or less so as to regulate a thickness difference between any two points, which are located within an area excepting an edge portion, of the membrane 62 as the final product to be 1 μm or less.

Preferably, a hardened layer is formed on the lip edge of the casting die 81. A method for forming the hardened layer is not especially limited. There are ceramic coating, hard chrome-plating, nitriding treatment method and so forth. When the ceramic is utilized as the hardened layer, it is preferable that the ceramic has grindable properties, low porosity, strength, excellent resistance to corrosion, and no affinity and no adhesiveness to the dope 24. Concretely, there are tungsten carbide (WC), Al₂O₃, TiN, Cr₂O₃ and so forth. Among these, the WC is especially preferable. It is possible to perform WC coating by a thermal spraying method.

It is preferable that a solvent supplying device (not shown) is attached near the lip edge of the casting die 81 in order to prevent the dope from being partially dried and solidified at the lip edge. It is preferable to supply a solvent to a peripheral portion of three-phase contact lines formed by both end portions of a casting bead, both end portions of the lip edge and ambient air. It is preferable to supply the solvent to each side of the end portions at a rate of 0.1 mL/min to 1.0 mL/min. Owing to this, foreign matter such as the solid contents separated out from the dope 24, or extraneous matter mixed into the casting bead from outside can be prevented from entering into the casting membrane 24a. As a pump for supplying the solvent, it is preferable to use the one having a pulsation rate of 5% or less.

The belt 82 under the casting die 81 is supported by the rollers 85 and 86. The belt 82 is continuously transported by the rotation of at least one of these rollers 85 and 86.

A width of the belt 82 is not especially limited. However, it is preferable that the width of the belt 82 is 1.1 to 2.0 times the casting width of the dope 24. Preferably, a length of the belt 82 is 20 m to 200 m, and a thickness thereof is 0.5 mm to 2.5 mm. It is preferable that the belt 82 is ground so as to have surface roughness of 0.05 μm or less.

A material of the belt 82 is not especially limited, but preferably stainless. As the material of the belt 82 besides stainless, there are nonwoven plastic films such as polyethylene terephthalate (PET) film, polybutylene terephthalate (PBT) film, nylon 6 film, nylon 6,6 film, polypropylene film, polycarbonate film, polyimide film and the like. It is preferable to use lengthy material having enough chemical stability for the used solvent and enough heat resistance to the membrane forming temperature.

It is preferable that a heat transfer medium circulator 87, which supplies a heat medium to the rollers 85 and 86 so as to control surface temperatures thereof, is attached to the rollers 85 and 86. For this configuration, a surface temperature of the belt 82 is kept at a predetermined value. In this embodiment, a passage (not shown) for the heat transfer medium is formed in the respective rollers 85 and 86. The heat transfer medium maintained at a predetermined temperature passes through the inside of the passage to keep a temperature of the respective rollers 85 and 86 at a predetermined value. The surface temperature of the belt 82 is appropriately set in accordance with a kind of the solvent, a kind of the solid contents, a concentration of the dope 24 and the like.

Instead of the rollers 85 and 86, and the belt 82, it is also possible to use a casting drum (not shown) as the support. In this case, it is preferable that the casting drum is capable of accurately rotating with rotational speed unevenness of 0.2% or less. Moreover, it is preferable that the casting drum has average surface roughness of 0.01 μm or less. The surface of the casting drum is hard chrome plated so as to have sufficient hardness and durability. Furthermore, it is preferable to minimize surface defect of the casting drum, belt 82, and rollers 85 and 86. Concretely, it is preferable that there is no pinhole of 30 μm or more, and a number of the pinholes of 10 μm or more and less than 30 μm is at most one per square meter, and a number of the pinholes of less than 10 μm is at most two per square meter.

It is preferable to dispose a decompression chamber 90 for controlling a pressure of the casting bead, which is formed between the casting die 81 and the belt 82, at its upstream side in the running direction of the belt 82.

Air blowers 91, 92 and 93 that blow air for vaporizing the solvent of the casting membrane 24a, and an air shielding plate 94 that prevents the air causing ununiformity in a shape of the casting membrane 24a from blowing onto the casting membrane 24a are provided near the casting die 81.

The casting chamber 63 is provided with a temperature regulator 97 for maintaining an inside temperature thereof at a predetermined value, and a condenser 98 for condensing and recovering solvent vapor. A recovery device 99 for recovering the condensed and devolatilized organic solvent is disposed at the outside of the casting chamber 63.

The poor solvent contact device 65 brings a liquid into contact with the membrane 62. This liquid is the poor solvent of the solid electrolyte that is combined with the catalyst in one dope. There are various ways to bring the liquid as the poor solvent into contact with the membrane 62. For example, the liquid as the poor solvent is sprayed onto the membrane 62. The membrane 62 may be fed into the atmosphere in which misted or vaporized poor solvent exists. It is also possible to soak the membrane 62 into a bath storing the liquid as the poor solvent, or to coat the membrane 62 with the liquid as the poor solvent. Among these methods, the misting, the use of the vaporized poor solvent and the coating are preferable. The position of the poor solvent contact device 65 is not limited to the configuration shown in FIG. 2. The poor solvent contact device 65 may be disposed, for example, right before the tenter drier 64 or between the tenter drier 64 and the drying chamber 69. However, the poor solvent contact device 65 is preferably disposed at a position where the drying of the layers containing the catalyst is not yet proceeded much.

The coating method is not particularly limited as long as the membrane 62 is continuously coated with the poor solvent. Preferably used are extrusion coating, die coaters such as slide and the like, roll coaters such as forward roll coater, reverse roll coater, gravure coater and the like, rod coater on which a thin metal wire is wound around, and the like. These methods are described in “Modern Coating and Drying Technology” edited by Edward Cohen and Edgar B. Gutoff (published by VCH Publishers, Inc., 1992). The rod coater, the gravure coater and a blade coater, which can be stably operated even when a small amount of the poor solvent is used for the coating, are preferable among them.

When a nonflammable liquid such as water is used as the poor solvent, it is possible to adopt the soaking, the spraying and the use of the misted or the gasified poor solvent.

As the misting or the spraying method, a spray nozzle which is utilized for air humidification, spray painting, automatic cleaning of a tank and so forth may be used. For example, a plurality of the spray nozzles is disposed along the width direction of the membrane 62 and spray the poor solvent onto the membrane 62 across the entire width thereof. As the spray nozzle, full cone spray nozzles, flat spray nozzles and the like manufactured by H. IKEUCHI & CO., LTD. or Spraying Systems Co. may be used.

In order to maintain high concentration of the gasified poor solvent in the atmosphere, evaporation of the poor solvent may be enhanced by the use of an atomizer, or volatilization of the poor solvent in liquid form may be enhanced by heat. Method of measuring gas concentration differs according to the type of the used poor solvent. The gas concentration may be measured by, for example, gas detecting tube, contact-combustion type gas detector, electrochemical gas detector, infrared gas detector and the like. When flammable poor solvent is used, it is preferable that nitrogen is preliminary substituted for air.

When the gasified poor solvent is brought into contact with the membrane 62, saturated vapor concentration in the atmosphere is preferably 60% to 95%, more preferably 60% to 90%, and further preferably 70% to 90%.

When the membrane 62 is fed into the atmosphere in which the concentration of the gasified poor solvent is high, it is ideal to make the membrane 62 into contact with the atmosphere until the membrane 62 reaches equilibrium, in which the concentrations of the reactants and products have no net change over time. However it is impossible to proceed the impregnation until the membrane 62 reaches the equilibrium, since the membrane 62 is continuously transported. Therefore, the time for making the membrane 62 into contact with the atmosphere is preferably in the range of 10 sec to 300 sec, more preferably 10 to 180 sec, and most preferably 30 sec to 300 sec.

The poor solvent is not strictly limited as long as it is a poor solvent of the solid electrolyte polymer that is combined with the catalyst in one dope. The solubility of the solid electrolyte in the poor solvent is preferably 1% or less. The poor solvent may be a mixture of a plurality of substances. However, substances that make the membrane 62 extremely white or cloudy, or extremely soft are not preferable. Those described in Shinpan Yozai Pokettobukku (The New Solvent Pocketbook) (published by Ohmsha, 1994) are the examples of the organic solvent to be the poor solvent, but the present invention is not limited to them. For example, alcohol group (methanol, ethanol, n-propanol, isopropanol, n-butanol, isobutanol, cyclohexanol, benzyl alcohol, fluorinated alcohol), keton group (acetone, methylethyl ketone, methyl isobutyl ketone, cyclohexanone), ester group (methylacetate, ethylacetate, butylacetate), polyalcohol group (ethylene glycol, diethylene glycol, propylene glycol, ethylene glycol diethyl ether), N,N-dimethylformamide, perfluorotributylamine, triethylamine, dimethylformamide, dimethylsulfoxide, methyl cellosolve, and the like.

A transfer section 101 that is disposed downstream from the casting chamber 63 is provided with an air blower 102. The edge slitting device 67 is provided with a crusher 103 for shredding side edges cut from the membrane 62.

The drying chamber 69 is provided with an absorbing device 106 to absorb and recover solvent vapor generated due to evaporation. In FIG. 2, the cooling chamber 71 is disposed downstream from the drying chamber 69. However, a humidity-controlling chamber (not shown) for controlling water content of the membrane 62 may be disposed between the drying chamber 69 and the cooling chamber 71. The neutralization device 72 is a forced neutralization device like a neutralization bar and the like, and capable of adjusting the charged voltage of the membrane 62 within a predetermined range (for example, −3 kV to +3 kV). Although the neutralization device 72 is disposed at the downstream side from the cooling device 71 in FIG. 2, this setting position is not exclusive. The knurling roller pair 73 forms knurling on both side edges of the membrane 62 by emboss processing. The inside of the winding chamber 76 is provided with a winding roller 107 for winding the membrane 62, and a press roller 108 for controlling tension at the time of winding.

Next, an embodiment of a method for producing the membrane 62 by using the above-described membrane producing apparatus 33 is described. The dope 24 is always uniformed by the rotation of the stirrer 78. Various additives may be mixed in the dope 24 during the stir.

The dope 24 is sent to the stock tank 32 by the pump 80, and deposition or aggregation of the solid contents in the dope 24 is inhibited by the stir. After that, the dope 24 is filtered by the filtration device 61 so as to remove the foreign matter having a size larger than a predetermined radius or foreign matter in a gel form.

The dope 24 is then cast from the casting die 81 onto the belt 82. In order to regulate the tension of the belt 82 to 10³ N/m to 10⁶ N/m, a relative position of the rollers 85 and 86, and a rotation speed of at least one of the rollers 85 and 86 are adjusted. Moreover, a relative speed difference between the belt 82 and the rollers 85 and 86 are adjusted so as to be 0.01 m/min or less. Preferably, speed fluctuation of the belt 82 is 0.5% or less, and meandering thereof caused in a width direction is 1.5 mm or less while the belt 82 makes one rotation. In order to control the meandering, it is preferable to provide a detector (not shown) for detecting the positions of both sides of the belt 82 and a position controller (not shown) for adjusting the position of the belt 82 according to detection data of the detector, and performs feed back control of the position of the belt 82. With respect to a portion of the belt 82 located just under the casting die 81, it is preferable that vertical positional fluctuation caused in association with the rotation of the roller 85 is adjusted so as to be 200 μm or less. Further, it is preferable that the temperature of the casting chamber 63 is adjusted within the range of −10° C. to 57° C. by the temperature regulator 97. Note that the solvent vaporized inside the casting chamber 63 is reused as dope preparing solvent after being collected by the recovery device 99.

The casting bead is formed between the casting die 81 and the belt 82, and the casting membrane 24a is formed on the belt 82. In order to stabilize a form of the casting bead, it is preferable that an upstream-side area from the bead is controlled by the decompression chamber 90 so as to be set to a desired pressure value. Preferably, the upstream-side area from the bead is decompressed within the range of −2500 Pa to −10 Pa relative to its downstream-side area from the casting bead. Incidentally, it is preferable that a jacket (not shown) is attached to the decompression chamber 90 to maintain the inside temperature at a predetermined temperature. Additionally, it is preferable to attach a suction unit (not shown) to an edge portion of the casting die 81 and suctions both sides of the bead in order to keep a desired shape of the casting bead. A preferable range of an air amount for aspirating the edge is 1 L/min to 100 L/min.

After the casting membrane 24a has possessed a self-supporting property, this casting membrane 24a is peeled from the belt 82 as the membrane 62 while supported by a peeling roller 109. The membrane 62 containing the solvent is carried along the transfer section 101 while supported by many rollers, and then fed into the tenter drier 64. In the transfer section 101, it is possible to give a draw tension to the membrane 62 by increasing a rotation speed of the downstream roller in comparison with that of the upstream roller. In the transfer section 101, dry air of a desired temperature is sent near the membrane 62, or directly blown to the membrane 62 from the air blower 102 to facilitate a drying process of the membrane 62. At this time, it is preferable that the temperature of the dry air is 20° C. to 250° C.

The membrane 62 fed into the tenter drier 64 is dried while carried in a state that both side edges thereof are held with holding devices such as clips 64a. At this time, pins may be used instead of the clips. The pins may be penetrated through the membrane 62 to support it. It is preferable that the inside of the tenter drier 64 is divided into temperature zones and drying conditions are properly adjusted in each zone. The membrane 62 may be stretched in a width direction by using the tenter drier 64. It is preferable that the membrane 62 is stretched in the casting direction and/or the width direction in the transfer section 101 and/or the tenter drier 64 such that a size of the film 62 after the stretching becomes 100.5% to 300% of the size of the same before the stretching.

After the membrane 62 is dried by the tenter drier 64 until the remaining solvent amount reaches a predetermined value, both edges thereof are cut off by the edge slitting device 67. The cut edges are sent to the crusher 103 by a cutter blower (not shown). The membrane edges are shredded by the crusher 103 and become chips. The chip is recycled for preparing the dope, and this enables effective use of the raw material. The slitting process for the membrane edges may be omitted. However, it is preferable to perform the slitting process between the casting process and the membrane winding process.

Meanwhile, the membrane 62 of which both side edges have been cut off is sent to the drying chamber 69 and is further dried. Although a temperature of the drying chamber 69 is not especially limited, it is determined in accordance with heat resistance properties (glass transition point Tg, heat deflection temperature under load, melting point Tm, continuous-use temperature and the like) of the solid electrolyte, and the temperature is preferably Tg or lower. In the drying chamber 69, the membrane 62 is carried while being bridged across the rollers 68, and the solvent gas vaporized therein is absorbed and recovered by the absorbing device 106. The air from which the solvent vapor is removed is sent again into the drying chamber 69 as the dry air. Incidentally, it is preferable that the drying chamber 69 is divided into a plurality of regions for the purpose of changing the sending air temperature. Meanwhile, in a case that a preliminary drying chamber (not shown) is provided between the edge slitting device 67 and the drying chamber 69 to preliminarily dry the membrane 62, a membrane temperature is prevented from rapidly increasing in the drying chamber 69. Thus, in this case, it is possible to prevent a shape of the membrane 62 from changing.

The membrane 62 is cooled in the cooling chamber 71 until the membrane temperature becomes about a room temperature. A moisture control chamber (not shown) may be provided between the drying chamber 69 and the cooling chamber 71. Preferably, air having desirable humidity and temperature is applied to the membrane 62 in the moisture control chamber. By doing so, it is possible to prevent the membrane 62 from curling and to prevent winding defect from occurring at the time of winding.

In the solution casting method, various steps such as the drying step, the edge slitting step and so forth are performed over the membrane 62 after it is peeled from the support and until it is wound up as the final product. During or between each step, the membrane 62 is mainly supported or transported by the rollers. Among these rollers, some are drive rollers and others are non-drive rollers. The non-drive rollers are used for determining a membrane passage, and at the same time for improving transport stability of the membrane 62.

While the membrane 62 is carried, the charged voltage thereof is kept in the predetermined range. The charged voltage is preferably at −3 kV to +3 kV after the neutralization. Further, it is preferable that the knurling is formed on the membrane 62 by the knurling roller pair 73. Incidentally, it is preferable that asperity height of the knurling portion is 1 μm to 200 μm.

The membrane 62 is wound up by the winding roller 107 contained in the winding chamber 76. At this time, it is preferable to wind the membrane 62 in a state that a desirable tension is given by the press roller 108. Preferably, the tension is gradually changed from the start of winding to the end thereof. Owing to this, the membrane 62 is prevented from being wound excessively tightly. It is preferable that a width of the membrane 62 to be wound up is not less than 100 mm. The present invention is applicable to a case in that a thin membrane of which thickness is 5 μm or more and 100 μm or less is produced.

A method of producing a solid electrolyte multilayer membrane having the catalyst layer and the solid electrolyte layer by co-casting two or more sorts of dopes is explained. The co-casting method may be a simultaneous co-casting method or a sequential co-casting method. When the simultaneous co-casting is performed, a feed block may be attached to the casting die, or a multi-manifold type casting die may be used.

The method of producing the solid electrolyte multilayer membrane according to the simultaneous co-casting method is explained with referring to FIG. 3. FIG. 3 shows a simultaneous co-casting device 111. In FIG. 3, the components identical to those shown in FIG. 2 are assigned with same numerals. The simultaneous co-casting device 111 forms a casting membrane 112 having a three-layer structure, and the obtained solid electrolyte multilayer membrane 62 is composed of three layers: a first surface layer 112a, a second surface layer 112b and an inner layer 112c. The first surface layer 112a is in contact with the belt 82. The second surface layer 112b is exposed to the air. The inner layer 112c is interposed between the first and the second surface layers 112a and 112b and not exposed outside.

A first dope 114 for forming the first surface layer 112a is cast such that it contacts with the belt 82. A second dope 115 forms the inner layer 112c, and a third dope 116 forms the second surface layer 112b. The first dope 114 and the third dope 116 include catalyst, which is described later. The first, second and third dopes 114, 115 and 116 sent through dope feeding passages L1, L2 and L3, respectively are fed to a feed block 119 attached to a casting die 89. The dopes are joined in the feed block 119 and simultaneously cast from the lip edge. In other words, in the feed block 119, three dope passages are formed. The dope passage placed in the middle of the three dope passages is for the second dope 115. The dope passage placed upstream from the middle passage in the running direction of the belt 82 is for the first dope 114. The dope passage placed downstream form the middle passage in the running direction of the belt 82 is for the third dope 116.

When the first and third dopes 114 and 116 forming the first and second surface layers 112a and 112b are each made to have a viscosity lower than that of the second dope 115 forming the inner layer 112c, the produced membrane hardly expresses abnormal characteristics such as melt fracture. When the dopes are cast after adjusting the viscosity of each dope in this way, the second dope 115 may be surrounded by the first dope 114 and the third dope 116 in the bead, which is formed from the casting die 89 to the belt 82. There are some cases that such bead is purposely formed. The first dope 114 and the third dope 116 may contain the poor solvent. In this case, poor solvent ratio of the first dope 114 and the third dope 116 may preferably be higher than that of the second dope 115. At this time, it is preferable that the first dope 114 is cast such that the first surface layer 112a, which is in contact with the belt 82, will have a thickness of 5 μm or more in a wet state. As the poor solvent, those used for the poor solvent contact device 65 (see FIG. 2) can be used.

In this way, the first, second and third dopes 113, 115 and 116 share the feed block 119 to be simultaneously co-cast from the casting die 89 having one casting opening. Instead of the feed block 119 and the casting die 89, it is also possible to use a casting die having three casting openings. When such casting die is used, the first, second and third dopes 114, 115 and 116 are cast from different openings. Three openings of this kind of casting die are arranged along the running direction of the belt 82.

Thickness of each layer 112a, 112b or 112c is not particularly restricted, however the first, second and third dopes 114, 115 and 116 are preferably cast such that the first and second surface layers 112a and 112b, that is, catalyst layers will each have the thickness of 10 μm to 500 μm.

Each dope 114, 115 or 116 may have the viscosity different from each other. However, it is preferable that the solid electrolyte in the first dope 114 and the third dope 116 is same as or compatible with that in the second dope 115.

Each dope 114, 115 or 116 may contain the additives different from each other. Specifically, the types or the concentration of the additives such as the above-described antioxidants, fibers, fine particles, water absorbing agents, plasticizers, compatibilizing agents and the like may be varied from dope to dope. For example, the antioxidants and fine particles (matting agents) may be added more to the first and third dopes 114 and 116 forming the surface layers as compared to the second dope 115 forming the inner layer. Alternatively, the antioxidants and fine particles may be added only to the first and third dopes 114 and 116. Meanwhile, the water absorbing agents, plasticizers, compatibilizing agents may be added more to the second dope 115 forming the inner layer as compared to the first and third dopes 114 and 116 forming the surface layers. Alternatively, the water absorbing agents, plasticizers, compatibilizing agents may be added only to the second dope 115. There is another configuration that the antioxidants having a low volatility are contained in the surface layers 112a and 112b, while the plasticizers having an excellent plasticity and the water absorbing agents having a high water-absorbing property are contained in the inner layer 112c. There is further another configuration that peeling agents are added only to the first dope 114 forming the first surface layer 112a being in contact with the belt 82. Thus each layer can independently have desirable functions by adjusting the types or concentration of the additives. Moreover, the dopes of the present invention are capable of forming different sort of function layers (for example, catalyst layer, antioxidant layer, antistatic layer, lubricating layer and the like) simultaneously.

In order to give lubricating property to the produced membrane, fine particles are preferably contained in the surface layers. Note that at least one of the surface layers 112a and 112b should contain the fine particles so that the produced membrane comes to have lubricity. Apparent specific gravity of the fine particle is preferably 70 g/liter or more, more preferably 90 g/liter to 200 g/liter, and further preferably 100 g/liter to 200 g/liter. The produced dispersion liquid can have higher concentration of the fine particles as the apparent specific gravity of the fine particle is larger. When silicon dioxide is used as the fine particles, average diameter of an initial particle is preferably 20 nm or less and the apparent specific gravity is preferably 70 g/liter or more. Such silicon dioxide fine particles can be obtained by, for example, burning a mixture of vaporized silicon tetrachloride and hydrogen in the air at a temperature of 1000° C. to 1200° C. Beside the silicon dioxide fine particles obtained by the above method, AEROSIL® 200V or AEROSIL® R972V (manufactured by NIPPON AEROSIL CO., LTD.) may be used.

The method of producing the solid electrolyte multilayer membrane according to the sequential co-casting method is explained with referring to FIG. 4. FIG. 4 shows a sequential co-casting device 121. The sequential co-casting device 121 is provided with three casting dies 122, 123 and 124. These casting dies 122, 123 and 124 are sequentially disposed along the belt 82. The casting die 122 casts the first dope 114, the casting die 123 casts the second dope 115 and the casting die 124 casts the third dope 116.

When the first, second and third dopes 114, 115 and 116 of the same composition are sequentially co-cast, the membrane production speed can be improved as compared to that in a single layer casting. In this case, the positions of the second and the third casting dies 123 and 124 are determined according to the drying speed and the like of the preceding layer. For example, it is preferable to dispose the second casting die 123 at a position where a ratio of the distance between the most upstream casting die 122 and the second casting die 123 to the distance between the most upstream casting die 122 and the position at which the casting membrane is peeled is in a range of 30% to 60%.

Besides the above methods, following method is also available as an example of the co-casting method. A first dope is cast from a first casing die onto a support to form a membrane, and the membrane is peeled off. With transporting the peeled membrane while supporting it by rollers, a second dope is cast from a second casting die onto the peeled surface of the peeled membrane to form a double-layer membrane.

Regardless of the single layer casting method or the co-casting method, there are various methods for casting the dope. For example, a method to uniformly extrude the dope from the pressurizing die, a doctor blade method, a reverse roll coating method and the like. In the doctor blade method, the dope is cast on the support and smoothed by the blade so as to adjust the membrane thickness. In the reverse roll coating method, a casting amount of the dope is adjusted by smoothing the surface of the dope by using rollers rotating reversely to one another. Above all, the method using the pressurizing die is preferable. As the pressurizing die, there are a coat-hanger type die, T-type die and so forth. Any type of the pressurizing die is preferably used.

Instead of the above-described method for forming the solid electrolyte into a membrane, it is possible to infiltrate the solid electrolyte into micropores of a so-called porous substrate in order to produce different type of the solid electrolyte membrane. As such method of producing the solid electrolyte membrane, there are a method in which a sol-gel reaction liquid containing the solid electrolyte is applied to the porous substrate so that the sol-gel reaction liquid is infiltrated into the micropores thereof, a method in which such porous substrate is dipped in the sol-gel reaction liquid containing the solid electrolyte to thereby fill the micropores with the solid electrolyte, and the like. Preferred examples of the porous substrate are porous polypropylene, porous polytetrafluoroethylene, porous cross-linked heat-resistant polyethylene, porous polyimide, and the like. Additionally, it is also possible to process the solid electrolyte into a fiber form and fill spaces therein with other polymer compounds, and forms this fiber into a membrane to produce the solid electrolyte membrane. In this case, for example, those used as the additives in the present invention may be used as the polymer compounds to fill the spaces.

The solid electrolyte membrane of the present invention is appropriately used for the fuel cell, especially as a proton conducting membrane for a direct methanol fuel cell. Besides that, the solid electrolyte membrane of the present invention is used as a solid electrolyte membrane interposed between the two electrodes of the fuel cell. Moreover, the solid electrolyte membrane of the present invention is used as an electrolyte for various cells (redox flow cell, lithium cell, and the like), a display element, an electrochemical censor, a signal transfer medium, a condenser, an electrodialysis, an electrolyte membrane for electrolysis, a gel actuator, a salt electrolyte membrane, a proton-exchange resin, and the like.

(Fuel Cell)

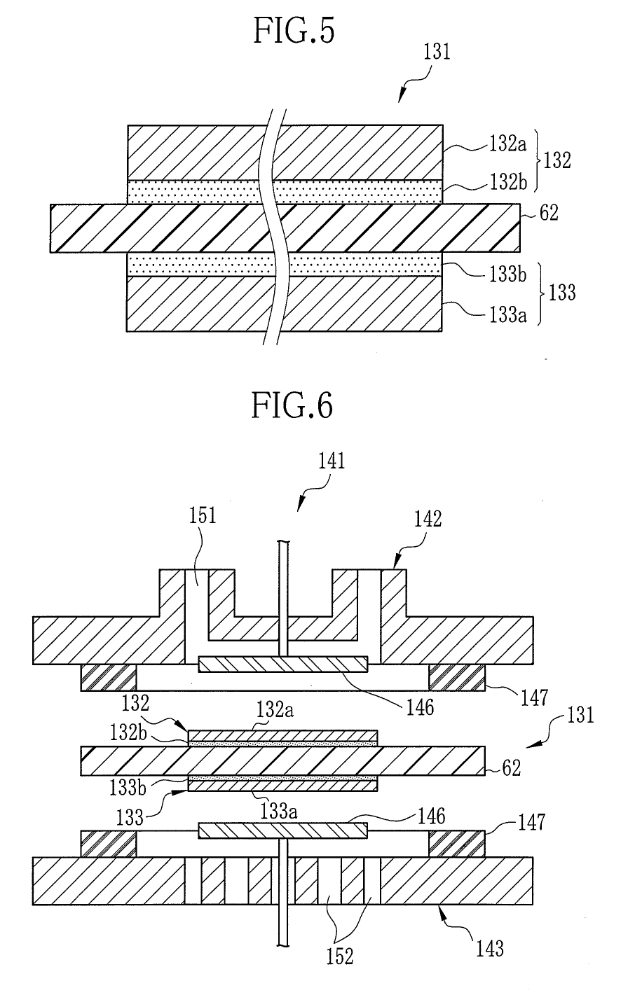

Hereinafter, an example of using the solid electrolyte membrane in a Membrane Electrode Assembly (hereinafter, MEA) and an example of using this MEA in a fuel cell are explained. Note, however, that forms of the MEA and the fuel cell described here are just an example and the present invention is not limited to them. In FIG. 5, a MEA 131 has the membrane 62 and an anode 132 and a cathode 133 opposing each other. The membrane 62 is interposed between the anode 132 and the cathode 133.

The anode 132 has a porous conductive sheet 132a and a catalyst layer 132b contacting the membrane 62, whereas the cathode 133 has a porous conductive sheet 133a and a catalyst layer 133b contacting the membrane 62. As the porous conductive sheets 132a and 133a, there are a carbon sheet and the like. The catalyst layers 132b and 133b are made of a dispersed substance in which catalyst metal-supporting carbon particles are dispersed in the proton conducting material. As the catalyst metal, there are platinum and the like. As the carbon particles, there are, for example, ketjen black, acetylene black, carbon nanotube (CNT) and the like. As the proton conducting material, there are, for example, Nafion (registered trademark) and the like.

As a method of producing the MEA 131, the following four methods are preferable.

(1) Proton conducting material coating method: A catalyst paste (ink) that has an active metal-supporting carbon, a proton conducting material and a solvent is directly applied onto both surfaces of the membrane 62, and the porous conductive sheets 132a and 133a are (thermally) adhered under pressure thereto to form a five-layered MEA.

(2) Porous conductive sheet coating method: A liquid containing the materials of the catalyst layers 132b and 133b, that is, for example the catalyst paste is applied onto the porous conductive sheets 132a and 133a to form the catalyst layers 132b and 133b thereon, and the membrane 62 is adhered thereto under pressure to form a five-layered MEA.

(3) Decal method: The catalyst paste is applied onto polytetrafluoroethylene (PTFE) to form the catalyst layers 132b and 133b thereon, and the catalyst layers 132b and 133b alone are transferred to the membrane 62 to form a three-layer structure. The porous conductive sheets 132a and 133a are adhered thereto under pressure to form a five-layered MEA.

(4) Catalyst post-attachment method: Ink prepared by mixing a carbon material not supporting platinum and the proton conducting material is applied onto the membrane 62, the porous conductive sheet 132a and 133a or the PTFE to form a membrane. After that, the membrane is impregnated with liquid containing platinum ions, and platinum particles are precipitated in the membrane through reduction to thereby form the catalyst layers 132b and 133b. After the catalyst layers 132b and 133b are formed, the MEA 131 is formed according to one of the above-described methods (1) to (3).

Note that the method of producing the MEA is not limited to the above-described methods, but various well-known methods are applicable. Besides the methods (1) to (4), there is, for example, the following method. A coating liquid containing the materials of the catalyst layers 132b and 133b is previously prepared. The coating liquid is applied onto supports and dried. The supports having the catalyst layers 132b and 133b formed thereon are adhered so as to contact with both surfaces of the membrane 62 under pressure. After peeling the supports therefrom, the membrane 62 having the catalyst layers 132b and 133b on both surfaces is interposed by the porous conductive sheets 132a and 133a. The porous conductive sheets 132a and 133a and the catalyst layers 132b and 133b are tightly adhered to form a MEA 131.

In FIG. 6, a fuel cell 141 has the MEA 131, a pair of separators 142, 143 holding the MEA 131 therebetween, current collectors 146 made of a stainless net attached to the separators 142, 143, and gaskets 147. The fuel cell 141 is illustrated in exploded fashion in FIG. 6 for the sake of convenience of explanation, however, each element of the fuel cell 141 are adhered to each other to be used as a fuel cell. The anode-side separator 142 has an anode-side opening 151 formed through it; and the cathode-side separator 143 has a cathode-side opening 152 formed through it. Vapor fuel such as hydrogen or alcohol (methanol and the like) or liquid fuel such as aqueous alcohol solution is fed to the cell via the anode-side opening 151; and an oxidizing gas such as oxygen gas or air is fed thereto via the cathode-side opening 152.

For the anode 132 and the cathode 133, for example, a catalyst that supports active metal particles of platinum or the like on a carbon material may be used. The particle size of the active metal particles that are generally used in the art is from 2 nm to 10 nm. Active metal particles having a smaller particle size may have a larger surface area per the unit weight thereof, and are therefore more advantageous since their activity is higher. If too small, however, the particles are difficult to disperse with no aggregation, and it is said that the lowermost limit of the particle size will be 2 nm or so.

In hydrogen-oxygen fuel cells, the active polarization of cathode, namely air electrode is higher than that of anode, namely hydrogen electrode. This is because the cathode reaction, namely oxygen reduction is slow as compared with the anode reaction. For enhancing the oxygen electrode activity, usable are various platinum-based binary alloys such as Pt—Cr, Pt—Ni, Pt—Co, Pt—Cu, Pt—Fe. In a direct methanol fuel cell in which aqueous methanol is used for the anode fuel, usable are platinum-based binary alloys such as Pt—Ru, Pt—Fe, Pt—Ni, Pt—Co, Pt—Mo, and platinum-based ternary alloys such as Pt—Ru—Mo, Pt—Ru—W, Pt—Ru—Co, Pt—Ru—Fe, Pt—Ru—Ni, Pt—Ru—Cu, Pt—Ru—Sn, Pt—Ru—Au in order to inhibit the catalyst Poisoning with CO that is formed during methanol oxidation. For the carbon material that supports the active metal thereon, preferred are acetylene black, Vulcan XC-72, ketjen black, carbon nanohorn (CNH) and CNT.

The function of the catalyst layers 132b, 133b includes (1) transporting fuel to active metal, (2) providing the reaction site for oxidation of fuel (anode) or for reduction of fuel (cathode), (3) transmitting the electrons released in the redox reaction to the current collector 146, and (4) transporting the protons generated in the reaction to the solid electrolyte, namely the membrane 62. For (1), the catalyst layers 132b, 133b must be porous so that liquid and vapor fuel may penetrate into the depth thereof. The catalyst supporting active metal particles on a carbon material works for (2); and the carbon material works for (3). For attaining the function of (4), the catalyst layers 132b, 133b contain a proton conducting material added thereto. The proton conducting material to be in the catalyst layers 132b, 133b is not specifically defined as long as it is a solid that has a proton-donating group. The proton conducting material may preferably be acid residue-having polymer compounds that are used for the membrane 62 such as perfluorosulfonic acids, as typified by Nafion (registered trademark); poly(meth)acrylate having a phosphoric acid group in side chains; sulfonated heat-resistant aromatic polymers such as sulfonated polyether etherketones and sulfonated polybenzimidazoles. When the solid electrolyte for the membrane 62 is used for the catalyst layers 132b, 133b, the membrane 62 and the catalyst layers 132b, 133b are formed of a material of the same type. As a result, the electrochemical adhesiveness between the solid electrolyte and catalyst layer becomes high. Accordingly, this is advantageous in terms of the ionic conductivity. The amount of the active metal to be used herein is preferably from 0.03 mg/cm² to 10 mg/cm² in view of the cell output and economic efficiency. The amount of the carbon material that supports the active metal is preferably from 1 to 10 times the weight of the active metal. The amount of the proton conducting material is preferably from 0.1 to 0.7 times the weight of the active metal-supporting carbon.

The anode 132 and the cathode 133 act as current collectors (power collectors) and also act to prevent water from staying therein to worsen vapor permeation. In general, carbon paper or carbon cloth may be used. If desired, the carbon paper or the carbon cloth may be processed with PTFE so as to be repellent to water.

The MEA has a value of area resistance preferably at 3 Ωcm² or less, more preferably at 1 Ωcm² or less, and most preferably at 0.5 Ωcm² or less according to alternating-current (AC) impedance method in a state that the MEA is incorporated in a cell and the cell is filled with fuel. The are a resistance value is calculated by a product of the measured resistance value and a sample area.

Fuel for fuel cells is described. For anode fuel, usable are hydrogen, alcohols (methanol, isopropanol, ethylene glycol and the like), ethers (dimethyl ether, dimethoxymethane, trimethoxymethane and the like), formic acid, boronhydride complexes, ascorbic acid, and so forth. For cathode fuel, usable are oxygen (including oxygen in air), hydrogen peroxide, and so forth.

In direct methanol fuel cells, the anode fuel may be aqueous methanol having a methanol concentration of 3 wt. % to 64 wt. %. As in the anode reaction formula (CH₃OH+H₂O→CO₂+6H⁺+6e⁻), 1 mol of methanol requires 1 mol of water, and the methanol concentration at this time corresponds to 64 wt. %. A higher methanol concentration in fuel is more effective for reducing the weight and the volume of the cell including a fuel tank of the same energy capacity. However, if the methanol concentration is too high, much methanol may penetrate through the solid electrolyte to reach the cathode on which it reacts with oxygen to lower the voltage. This is so-called the crossover phenomenon. When the methanol concentration is too high, the crossover phenomenon is remarkable and the cell output tends to lower. In view of this, the optimum concentration of methanol shall be determined depending on the methanol perviousness through the solid electrolyte used. The cathode reaction formula in direct methanol fuel cells is (3/2) O₂+6H⁺+6e⁻→H₂O, and oxygen (generally, oxygen in air) is used for the fuel in the cells.

For supplying the anode fuel and the cathode fuel to the respective catalyst layers 132b and 133b, there are two applicable methods: (1) a method of forcedly sending the fuel by the use of an auxiliary device such as pump (active method), and (2) a method not using such an auxiliary device, in which liquid fuel is supplied through capillarity or by spontaneously dropping it, and vapor fuel is supplied by exposing the catalyst layer to air (passive method). It is also possible to combine the methods (1) and (2). In the method (1), high-concentration methanol is usable as fuel, and air supply enables high output from the cells by extracting water formed in the cathode area. These are the advantages of the method (1). However, this method has the disadvantage in that the necessary fuel supply unit will make it difficult to downsize the cells. On the other hand, the advantage of the method (2) is capability of downsizing the cells, but the disadvantage thereof is that the fuel supply rate is readily limited and high output from the cells is often difficult.

Unit cell voltage of fuel cells is generally at most 1 V. Therefore, the unit cells are stacked up in series depending on the necessary voltage for load. For cell stacking, employable methods are a method of “plane stacking” that arranges the unit cells on a plane, and a method of “bipolar stacking” that stacks up the unit cells via a separator with a fuel pathway formed on both sides thereof. In the plane stacking, the cathode (air electrode) is on the surface of the stacked structure and therefore it readily takes air thereinto. In addition, since the stacked structure may be thinned, it is more favorable for small-sized fuel cells. Besides the above-described methods, MEMS technology may be employed, in which a silicon wafer is processed to form a micropattern and fuel cells are stacked thereon.

Fuel cells may have many applications for automobiles, electric and electronic appliances for household use, mobile devices, portable devices, and the like. In particular, direct methanol fuel cells can be downsized, the weight thereof can be reduced and do not require charging. Having such many advantages, they are expected to be used for various energy sources for mobile appliances and portable appliances. For example, mobile appliances in which fuel cells are favorably used include mobile phones, mobile notebook-size personal computers, electronic still cameras, PDA, video cameras, mobile game machines, mobile servers, wearable personal computers, mobile displays and the like. Portable appliances in which fuel cells are favorably used include portable generators, outdoor lighting devices, pocket lamps, electrically-powered (or assisted) bicycles and the like. In addition, fuel cells are also favorable for power sources for robots for industrial and household use and for other toys. Moreover, they are further usable as power sources for charging secondary batteries that are mounted on these appliances.

### Example 1

Hereinafter, examples of the present invention are explained. In the following description, Experiment 1 of Example 1 and Experiment 1 of Example 2 are explained in detail. With respect to Experiments 2 to 7 of Example 1 and Experiments 2 to 6 of Example 2, conditions different from each Experiment 1 of Examples 1 and 2 are only explained. Note that Experiments 2 to 6 of Example 1 and Experiments 2 to 5 of Example 2 are the examples of the embodiments of the present invention. Experiments 1 and 7 of Example 1, and Experiments 1 and 6 of Example 2 are the comparative experiments of the embodiments of the present invention.

### Experiment 1

{Production of First, Second and Third dopes 114, 115 and 116}

A material A was condensed by the flash device 26 and dried. Solid contents containing the dried material A was dissolved in the solvent according to the following composition, and the dopes having the solid contents of 30 wt. % were produced. The solvent was perfluorohexane. Note that catalyst fine particles did not dissolve in, but dispersed in the solvent. Additive rate of dichloromethane to the dope was varied in each Experiment 1 to 7 as shown in Table 1. The dichloromethane was the poor solvent of the dried material A. The dichloromethane was added to the first dope 114 and the third dope 116, but was not added to the second dope 115. Each Experiment 1 to 7 was performed with varying the additive rate of dichloromethane that was the poor solvent of the dried material A. The first to third dopes 114 to 116 in Experiments 1 to 7 all had 30 wt. % of the solid contents concentration. Note that the material A was 20% Nafion (registered trademark) Dispersion Solution DE2020 (manufactured by US Dupont).

| | |
|---|---|
| First dope 114: | |
| Dried material A | 80 pts. wt |
| Pt catalyst fine particles TEC10E50E | 20 pts. wt |
| (manufactured by Tanaka Kikinzoku Kogyo K.K.) | |
| Second dope 115: | |
| Dried material A | |
| Third dope 116: | |
| Dried material A | 80 pts. wt |
| Pt—Ru catalyst fine particles TEC61E54 | 20 pts. wt |
| (manufactured by Tanaka Kikinzoku Kogyo K.K.) | |

{Production of Solid Electrolyte Multilayer Membrane 62}

The solid electrolyte multilayer membrane having three-layer structure was produced by the simultaneous co-casting device 111 according to the following method. After the drying, the solid electrolyte multilayer membrane 62 was made to have the total thickness of 140 μm in which the first surface layer, the second surface layer and the inner layer were made to have the thickness of 20 μm, 20 μm and 100 μm, respectively. The casting width was 380 mm, and the flow amount of each dope was adjusted during the co-casting. The casting die 89 was provided with a jacket (not shown) in which a heat transfer medium was supplied. A temperature of the heat transfer medium was regulated at 40° C. so as to maintain the temperature of each first to third dope 114 to 116 at 40° C.

The temperatures of the casting die 89, the feed block 119, and the dope feeding passages L1 to L3 for the first to third dopes 114 to 116 were all maintained at 40° C. The casting die 89 was the coat-hanger type and had the width of 0.4 m. The heat bolts provided to the casting die 89 for adjusting the membrane thickness were disposed at the pitch of 20 mm. The casting die 89 had the automatic thickness adjusting mechanism for adjusting the slit clearance thereof. The profile of the heat bolt could be set corresponding to the flow amounts of the first to third dopes 114 to 116 by the accuracy gear pump, on the basis of the preset program. Thus the feed back control could be made by the control program on the basis of the profile of an infrared ray thickness meter (not shown) disposed in the membrane producing apparatus 33. The slit clearance of the lip edge was adjusted such that, with exception of both side edge portions (specifically, 20 mm each in the widthwise direction of the produced membrane), the difference of the membrane thickness between any two points which were 50 mm apart from each other might be at most 1 μm, and the largest difference between the minimal values of the membrane thickness in the widthwise direction might be at most 3 μm/m. Moreover, the slit clearance of the lip edge was adjusted such that the average thickness accuracy of each surface layer might be at most ±2%, that of the inner layer might be at most ±1%, and the average membrane thickness might be at most ±1.5%.

In order to prevent the dope from partially drying and solidifying at the lip edge of the casting die 89, a liquid used as the solvent of the dope was supplied to three-phase contact lines formed by both end portions of the casting bead, both end portions of the lip edge and ambient air at a rate of 0.5 ml/min. The pulse rate of a pump for supplying the liquid was at most 5%.

The material of the belt 82 was SUS316 having enough corrosion resistance and strength. The belt 82 was polished such that the surface roughness might be at most 0.05 μm. The thickness of the belt 82 was 1.5 mm and the thickness unevenness thereof was at most 0.5%. The belt 82 was moved by rotating the rollers 85 and 86, and the relative speed between the rollers 85, 86 and the belt 82 was at most 0.01 m/min. The speed fluctuation of the belt 82 was at most 0.5%. The positions of both sides of the belt 82 were detected so as to control the position of the belt 82. The position of the belt 82 was controlled such that the meandering thereof in the width direction might be at most 1.5 mm while the belt 82 makes one rotation. The distance fluctuation between the lip edge and the belt 82 was regulated to be at most 200 μm. In the casting chamber 63, a wind pressure fluctuation controller (not shown) for controlling the wind pressure fluctuation inside of the casting chamber 63 was provided.

The first, second and third dopes 114, 115 and 116 were cast so as to form the casting membrane 112. The dry air of 50° C. to 70° C. was applied to the casting membrane 112 by the air blowers 91, 92 and 93 so as to dry the casting membrane 112 until the solvent content thereof reached 30 wt. % with respect to the solid contents of the material A, namely the solid electrolyte. After the casting membrane 112 had possessed a self-supporting property, the casting membrane 112 was peeled from the belt 82 as the membrane 62. The membrane 62 was fed into the tenter drier 64 and transported therein in a state that both side edges thereof were held with the clips 64a. In the tenter drier 64, the membrane 62 was dried until the solvent content thereof reached 15 wt. % with respect to the solid contents by the dry air of 140° C. The membrane 62 was then released from the clips 64a at an exit of the tenter drier 64, and both edges of the membrane 62 were cut off by the edge slitting device 67 disposed downstream from the tenter drier 64. The membrane 62 of which both side edges had been cut off was sent to the drying chamber 69 and was further dried at the temperature of 160° C. to 180° C. while transported by the rollers 68. In this way, the solid electrolyte membrane 62 having a solvent content rate of less than 1% was obtained. A thickness of the obtained membrane 62 was 80 μm.

The obtained membrane 62 was evaluated in each of the following items. Evaluation results are shown in Table 1. Note that the number of the evaluation items in Table 1 correspond to the number assigned to each of the following items.

1. Thickness

Thickness of the membrane 62 was continuously measured at a speed of 600 mm/min. by the use of an electronic micrometer manufactured by Anritsu Electric Co., Ltd. Data obtained by the measurement was recorded on a chart on a scale of 1/20, at a chart speed of 30 mm/min. After obtaining measurements of data curve by a ruler, an average thickness value of the membrane 62 and thickness unevenness relative to the average thickness value were obtained based on the obtained measurements. In Table 1, (a) represents the average thickness value (unit: μm) and (b) represents the thickness unevenness (unit: μm) relative to (a).

2. Ionic Conductivity Coefficient

On the obtained solid electrolyte multilayer membrane 62, ten measurement points each of which is 1 m apart from one another were selected along a longitudinal direction of the membrane 62. These ten measurement points were cut out into circular sample having a diameter of 13 mm. Each sample was interposed by a pair of stainless plates, and the ionic conductivity coefficient of the sample was measured in accordance with the AC impedance method by the use of a Multichannel Battery Test System 1470 and 1255B manufactured by Solartron Co., Ltd. The measurement was performed under the condition of a temperature at 25° C. and a relative humidity of 100%. The ionic conductivity is represented by a value of the AC impedance (unit: S/cm) as shown in Table 1.

3. Output Density of Fuel Cell 141

The fuel cell 141 using the membrane 62 was formed, and output thereof was measured. According to the following methods, the fuel cell 141 was formed, and the output density thereof was measured.

(1) Formation of MEA 131

A carbon paper having a thickness of 350 μm was attached to both surfaces of the solid electrolyte membrane 62, and thermally adhered for 2 minutes at a temperature of 80° C. under a pressure of 3 MPa. In this way, a MEA 131 was formed.

(2) Output Density of Fuel Cell 141

The MEA fabricated in (1) was set in a fuel cell as shown in FIG. 6, and an aqueous 15 wt. % methanol solution was fed into the cell via the anode-side opening 151. At this time, the cathode-side opening 152 was kept open to air. The anode 132 and the cathode 133 were connected to the Multichannel Battery Test System (Solartron 1470), and the output density (unit: W/cm²) was measured.

TABLE 1

Evaluation Item

| | | |
|---|---|---|
| 1 (μm) | 2 | 3 |

| Example 1 | (a) | (b) | (×10⁻² S/cm) | (mW/cm²) |
|---|---|---|---|---|
| Experiment 1 | 33.7 | ±2.0 | 7.9 | 228 |
| Experiment 2 | 33.7 | ±2.0 | 8.1 | 331 |
| Experiment 3 | 33.8 | ±2.0 | 8.3 | 338 |
| Experiment 4 | 33.9 | ±2.0 | 8.4 | 375 |
| Experiment 5 | 34.0 | ±2.0 | 8.8 | 401 |
| Experiment 6 | 34.2 | ±2.0 | 8.3 | 441 |
| Experiment 7 | 34.2 | ±2.0 | 8.0 | 329 |

According to the results of Example 1, the value of a simple cell according to the AC impedance method and the output density of the fuel cell as the unit cell are both higher in Experiments 2 to 6 as compared to Experiment 1 which is a prior art and Experiment 7 which is the comparative example. In Experiments 2 to 6, an appropriate amount of the poor solvent of the solid electrolyte was added to the first and the third dopes 114 and 116 for the catalyst layer 132b and 133b. Accordingly, it will be understood that the solid electrolyte multilayer membrane of the present invention is suitably used for the fuel cell.

### Example 2

Solid contents containing a dried material B was dissolved in the solvent according to the following composition, and the first, second and third dopes 114, 115 and 116 having the solid contents of 30 wt. % were produced. The solvent was N-methylpyrrolidone. Note that catalyst fine particles did not dissolve in, but dispersed in the solvent. Note that the material B was sulfonated polyacrylonitrile styrene.

| | |
|---|---|
| First dope 114: | |
| Dried material B | 10 pts. wt |
| Pt catalyst fine particles TEC10E50E | 20 pts. wt |
| (manufactured by Tanaka Kikinzoku Kogyo K.K.) | |
| Second dope 115: | |
| Dried material B | |
| Third dope 116: | |
| Dried material B | 10 pts. wt |
| Pt—Ru catalyst fine particles TEC61E54 | 20 pts. wt |
| (manufactured by Tanaka Kikinzoku Kogyo K.K.) | |

### {Production of Solid Electrolyte Multilayer Membrane 62}

Instead of the first to third dopes 114 to 116 of Example 1, the above-noted first to third dopes 114 to 116 were used. The temperatures of the dry air from the air blowers 91, 92 and 93 were regulated to be 100° C. to 120° C. A thickness of each membrane produced in this Example 2 was 35 μm. In Experiment 2, water was sprayed onto the just peeled membrane 62 fed out of the casting chamber 63. The spraying was performed by the use of an atomizer manufactured by H. IKEUCHI & CO., LTD. Note that water was the poor solvent of the material B. In Experiment 3, the spraying was performed at the exit of the tenter drier 64. In Experiment 4, water was added to the just peeled membrane 62 by vapor humidification. In Experiment 5, water was added to the membrane 62 at the exit of the tenter drier 64 by the vapor humidification. In Experiment 6, water was added to the dry membrane before wound up by the vapor humidification. In Experiment 1, water was not added at all. Other conditions were same as Example 1. Evaluation results of the obtained membrane 62 are shown in Table 2.

TABLE 2

Evaluation Item

| | | |
|---|---|---|
| 1 (μm) | 2 | 3 |

| Example 2 | (a) | (b) | (×10⁻² S/cm) | (mW/cm²) |
|---|---|---|---|---|
| Experiment 1 | 33.7 | ±2.0 | 7.9 | 228 |
| Experiment 2 | 33.7 | ±2.0 | 8.1 | 331 |
| Experiment 3 | 33.8 | ±2.0 | 8.3 | 348 |
| Experiment 4 | 33.9 | ±2.0 | 8.4 | 385 |
| Experiment 5 | 34.0 | ±2.0 | 8.8 | 351 |
| Experiment 6 | 34.2 | ±2.0 | 8.0 | 229 |

According to the results of Example 2, the value of a simple cell according to the AC impedance method and the output density of the fuel cell as the unit cell are both higher in Experiments 2 to 5 as compared to Experiment 1 which is a prior art and Experiment 6 which is the comparative example. In Experiments 2 to 5, an appropriate amount of the poor solvent of the solid electrolyte was applied to the surfaces of the catalyst layer 132b, 133b before fully dried. Accordingly, it will be understood that the solid electrolyte multilayer membrane of the present invention is suitably used for the fuel cell.

From the results of the above-mentioned examples, it will be understood that it is possible to continuously produce the solid electrolyte multilayer membrane having excellent planarity and reduced defects according to the present invention. It will be also understood that the obtained solid electrolyte multilayer membrane can be appropriately used as the solid electrolyte layer for the fuel cell.

### INDUSTRIAL APPLICABILITY

The solid electrolyte multilayer membrane, the method and the apparatus of producing the same, the membrane electrode assembly and the fuel cell using the solid electrolyte multilayer membrane of the present invention are applicable to the power sources for various mobile appliances and various portable appliances.

1. A method of producing a solid electrolyte multilayer membrane, comprising the steps of:
casting a first dope and a second dope onto a running support so as to form a casting membrane having a first layer of said first dope and a second layer of said second dope, said first dope containing an organic solvent and a solid electrolyte being a solid electrolyte layer of a fuel cell, said second dope containing said solid electrolyte, said organic solvent and a catalyst promoting a redox reaction of electrodes in said fuel cell;
peeling said casting membrane as a wet membrane from said support;
performing a first drying of said wet membrane in a state that both side edges thereof are held by holding devices; and
performing a second drying of said wet membrane supported by rollers to form said solid electrolyte multilayer membrane, said second drying step being performed after said first drying step.

2. A method described in claim 1, wherein said first dope is cast from a first casting die and said second dope is cast from a second casting die disposed at a downstream of said first casting die.

3. A method described in claim 1, wherein said wet membrane is brought into contact with a compound that is a poor solvent of said solid electrolyte.

4. A method described in claim 1, wherein said catalyst includes at least one of Au, Ir, Pt, Rh, Ru, W, Ta, Nb, Ti Pd, Bi, Ni, Co, Fe and Hf.

5. A method described in claim 1, wherein a thickness of a layer formed from said first dope in said solid electrolyte multilayer membrane is 20 μm to 800 μm, said layer being derived from said first layer of said casting membrane.

6. A method described in claim 1, wherein a thickness of a layer formed from said second dope in said solid electrolyte multilayer membrane is 10 μm to 500 μm, said layer being derived from said second layer of said casting membrane.

7. A method described in claim 1, wherein a third dope containing said solid electrolyte, said organic solvent and said catalyst is cast such that said first dope is interposed between said second dope and said third dope.

8. A method described in claim 2, wherein a third dope containing said solid electrolyte, said organic solvent and said catalyst is cast from a third casting die disposed at an upstream of said first casting die.

9. A method described in claim 7, wherein said catalyst in said second dope and said catalyst in said third dope are different from each other.

10. An apparatus of producing a solid electrolyte multilayer membrane, comprising:
a casting device for casting plural dopes from a casting die onto a running support so as to form a layered casting membrane and peeling said casting membrane as a layered wet membrane;
a first drying device for drying said wet membrane in a state that both side edges thereof are held by holding devices; and
a second drying device for drying said wet membrane supported by rollers to form said solid electrolyte multilayer membrane, said second drying device being disposed at a downstream of said first drying device, wherein
said plural dopes are a first dope and a second dope, said first dope containing an organic solvent and a solid electrolyte being a solid electrolyte layer of a fuel cell, and said second dope containing said solid electrolyte, said organic solvent and a catalyst promoting a redox reaction of electrodes in said fuel cell.

11. A solid electrolyte multilayer membrane produced by a method described in claim 1.

12. A membrane electrode assembly, comprising:
a solid electrolyte multilayer membrane described in claim 11;
an anode adhered to one surface of said solid electrolyte multilayer membrane, said anode generating protons from a hydrogen-containing material supplied from outside; and
a cathode adhered to the other surface of said solid electrolyte multilayer membrane, said cathode synthesizing water from said protons permeated through said solid electrolyte multilayer membrane and gas supplied from outside.

13. A fuel cell, comprising:
a membrane electrode assembly described in claim 12;
current collectors one of which provided in contact with said anode and the other of which provided in contact with said cathode, said current collector on said anode side receiving and passing electrons between said anode and outside, whereas said current collector on said cathode side receiving and passing said electrons between said cathode and outside.
